(19) United States
(12) Patent Application Publication
(10) Pub. No.: US 2016/0075546 A1
(43) Pub. Date: Mar. 17, 2016

(54) Sixtel Keg Tapping and Stacking Apparatus

(71) Applicant: Sean E. Cole, Lemon Grove, CA (US)

(72) Inventor: Sean E. Cole, Lemon Grove, CA (US)

(21) Appl. No.: 14/857,800

(22) Filed: Sep. 17, 2015

Related U.S. Application Data
(60) Provisional application No. 62/051,405, filed on Sep. 17, 2014.

(51) Int. Cl. B67D 1/08

(52) U.S. Cl. CPC B67D 1/0891

(57) ABSTRACT

The sixtel keg stacking apparatus is a device designed to create horizontal space efficiency by allowing sixtel kegs to be stacked while simultaneously being tapped and dispensed into a draught beer system. The apparatus offers similar function when utilized with cornelius kegs which have nominally the same dimensions as a sixtel keg. The device is intended to allow pub owners, beer retailers and homebrewers to decrease the square footage of refrigeration space necessary to store and dispense draught beer packaged in the newer, preferred sixtel and cornelius kegs. The apparatus enables these kegs to be vertically stacked upon each other and simultaneously dispensed

### BACKGROUND

Most U.S. Breweries distribute draught beer in standard U.S. keg sizes of ½ barrel (15.5 gallons), ¼ barrel (7.75 gallons) and ⅙ barrel “Sixtel” (5.17 gallons). There has been a recent shift toward the use of sixtel kegs, particularly by craft beer breweries, as sixtel kegs have a smaller circumference which allows retailers such as pub owners and beer resellers to store an increased variety of styles in the same space needed for fewer, larger half barrel kegs. Half barrel kegs are 16 inches in circumference while sixtel kegs are 9 inches. Another precipitant to the Industry's shift toward packaging draught beer in sixtel kegs is revenue. A half barrel of a craft style beer may cost between $150-200 while a sixtel (one-third the volume of a half barrel) of the same beer can fetch $75-100. The revenue from the same amount of beer sold in sixtels instead of halves jumps to $225-300—a 33% increase! Lastly, craft brewery beer production levels are slight in comparison to recent regional and national demand for them. Distributing beer in sixtel kegs allows for wider fulfillment of product demand; albeit in smaller quantities. This has the effect of both increasing brand recognition and augmenting market areas.

Sixtel kegs are typically fitted with a standard U.S. Type D Sanke coupler receiver on a single downspout. Prior to coupling or “tapping” a keg with a Sanke coupler the kegs are precariously stackable. However, once tapped, the coupling mechanism (Tap) interferes with stacking as it, along with the beer and gas lines attached to the coupler, project upward beyond the collar rim of the bottom keg making stacking implausible. The ability to simultaneously stack and tap kegs creates vertical space efficiency in addition to the previously discussed horizontal circumference efficiency. While resolved years ago for half barrel kegs, no addition to the Art has been offered for the smaller, new to the scene, sixtel keg. The sixtel keg stacking apparatus was invented to create vertical space efficiency by affording the ability to tap and dispense sixtel kegs while simultaneously storing them multiple layers high.

Similar space efficiency and simultaneous tapping ability opportunity exists when the apparatus is utilized with 5 gallon Cornelius kegs (commonly referred to as “Corny” kegs) which are nominally the same dimension as a ⅙ barrel keg. Until recently, most soft drink manufacturers distributed soda syrup concentrate in stainless steel 5 gallon Corny kegs. Beverage distributors have largely abandoned the use of Corny kegs in favor of bag-in-a-box packaging. The national inventory of Corny kegs has been actively sought after by home brewers desiring to keg and dispense their home brewed libations on draught. As with sixtel kegs, a similar stacking issue exists when beer and gas lines are connected with ball-lock or pin-lock connectors typically utilized by Corny kegs. A common kegerator design employs the use of a wide, temperature controlled, chest freezer to refrigerate corny kegs, on a single level, in a multi faucet homebrew draught system. This apparatus will allow for the vertical and simultaneous stacking of corny kegs in a kegerator devised from an upright refrigerator (or temperature controlled upright freezer) thus creating horizontal footprint space savings over the utilization of wide, chest style freezer.

### BRIEF SUMMARY OF THE INVENTION

The sixtel keg stacking apparatus is a device designed to create horizontal space efficiency by allowing sixtel kegs to be stacked multiple layers high while simultaneously being tapped and dispensed into a draught beer system. The apparatus has upper and lower portions which are fastened together but may be separated. Each portion has a “collar” of sufficient height to receive the top or bottom of either sixtel keg being stacked and to maintain them in a stable vertical position in avoidance of tipping. When separated, the upper portion has three “collar fins” which project downward, and, in association with the upper collar, can be utilized to stack stored sixtel kegs sans tapping. Utilizing the upper portion alone creates additional vertical space savings by removing the lower collar and the incumbent space afforded by the design which was intended for simultaneous tapping while stacking. Utilizing the combined upper and lower portions of the apparatus, while fastened, achieves the dual function of simultaneous stacking and tapping. The apparatus functions similarly on Cornelius kegs.

### BRIEF DESCRIPTION OF DRAWINGS

FIG. 1. FIG. 1 is a view looking directly down on the apparatus. It shows the placement of screws which fasten the upper and lower portions together, the bottom support shelf of the upper collar upon which a stacked keg rests and the top edge of the circumferential side collar.

FIG. 2. FIG. 2 is an axonometric view of the apparatus wherein both the upper and lower portions are fastened together and the device is ready to be employed in the stacking and simultaneous tapping of two sixtel kegs. The lower portion, labelled bottom, slips over the lower keg while the keg above is cradled in the upper portion labelled top.

FIG. 3. FIG. 3 is a view looking directly upward at the bottom of the lower portion of the apparatus. It depicts the bottom side of the lower portion shelf which rests upon the lower keg. It also depicts the bottom edge of the circumferential side collar.

FIG. 4. FIG. 4 is a horizontal cut view looking directly downward at the apparatus. The horizontal cut occurs just above the terminus of the collar fins of the upper portion where they rest against the support risers of the lower portion. The view depicts the screw fastener points in each support riser as well as the proximate location of each support riser. Between and in the middle of each riser the top side of the lower portion shelf is depicted.

FIG. 5. FIG. 5 is an exploded axonometric view of the apparatus wherein both the upper and lower portions are separated vertically. Fasteners are pictured and indication is given, via downward dashed lines, as to the where the fasteners will be employed to perform the function of securing the upper and lower portions together.

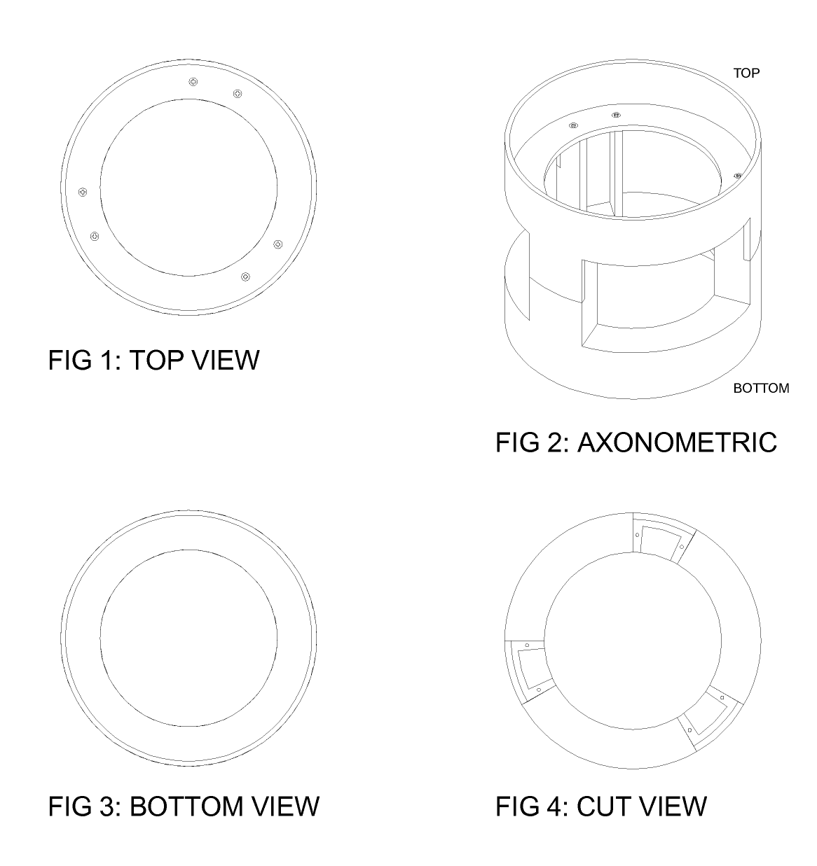

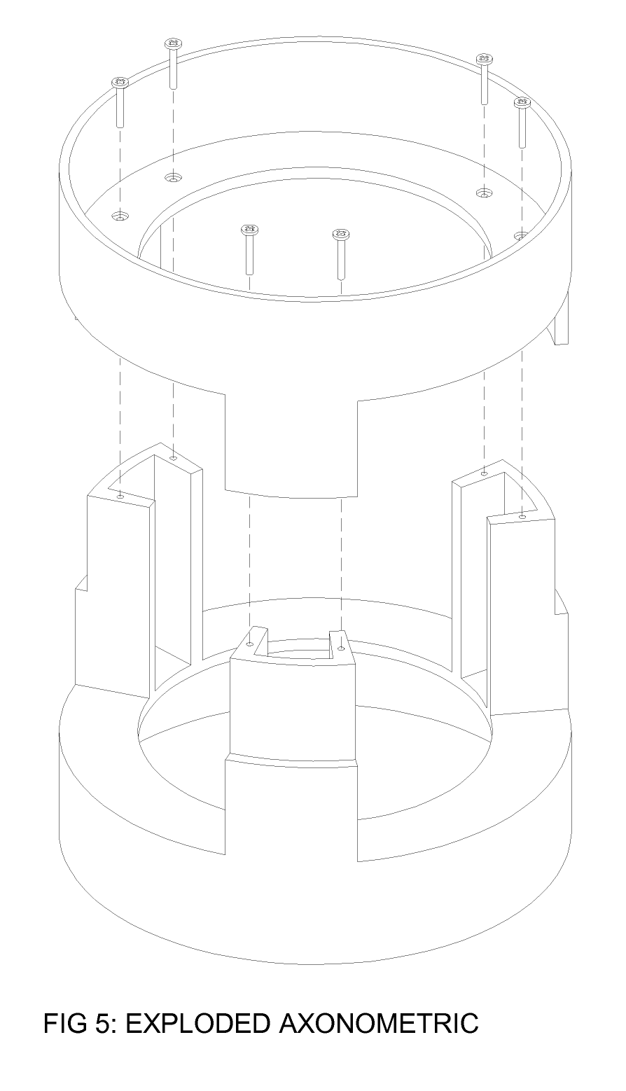

### DETAILED DESCRIPTION AND BEST MODE OF IMPLEMENTATION

The sixtel keg stacking apparatus is a device designed to create horizontal space efficiency by allowing sixtel kegs to be stacked while simultaneously being tapped and dispensed into a draught beer system. The apparatus offers similar function when utilized with cornelius kegs which have nominally the same dimensions as a sixtel keg. The device is intended to allow pub owners, beer retailers and homebrewers to decrease the square footage of refrigeration space necessary to store and dispense draught beer packaged in the newer, preferred sixtel and cornelius kegs. The apparatus enables these kegs to be vertically stacked upon each other and simultaneously dispensed.

The apparatus is manufactured using plastic injection mold processes and utilizes rigid and sturdy Acrylonitrile Butadiene Styrene (ABS) plastic to form its solid structure and to create a void of space between the two kegs, inside of which, the lower keg may tapped and dispensed. The invention design has incorporated the ability to separate the apparatus into upper and lower portions. The separated upper portion may be utilized for a dual purpose of simply stacking stored kegs when the function of simultaneous tapping is not required or desired. The usage of the upper portion in this manner creates stability in the keg stack and ensures slippage between, or tipping of, the kegs coupled by the stacker is avoided.

Each of the upper and lower portions of the apparatus has a collar which receives either the top or bottom of the respective keg it is to stack. Both collars are marginally larger in diameter than the outer circumference of the keg. The lower collar slips vertically over the outside of the bottom keg in the stack until the top of the keg reaches and stops at the shelf which rests upon the top rim of the keg. The shelf extends only to a distance sufficient to ensure it rests upon the rim of the keg the lower portion receives; leaving the central, circular portion open. It is through this opening which a coupler (tap), along with associated beer and gas lines may be presented and coupled with the lower keg for dispensing.

Protruding upward from the lower shelf along the outside edge of the apparatus are risers which create support for the upper portion of the apparatus and the keg which will rest within the upper portion's own collar. The risers are of such a height and distance apart so as to allow the coupler and beer lines to pass between and through them to the central opening in the lower portion shelf where again, they will perform their function of coupling to the keg and dispensing beer to the system. There are multiple risers and the space between any risers may be used to accomplish the tapping function. The top of each riser is molded to receive connecting fasteners which traverse vertically through holes in the upper portion shelf and ensure both the upper and lower portions are secured together tightly and solidly.

The apparatus' upper portion has a shelf and collar of similar design to the lower portion shelf. The upper portion collar protrudes upward from the upper portion shelf and the keg to be stacked is lowered into the collar until it rests upon the upper portion shelf. The keg may then be tapped, or alternately, another apparatus placed upon it. The floor space previously encompassed by the second stacked keg is no longer occupied thus creating a space efficiency wherein another use may be had.

1. I claim a stacking apparatus device which creates horizontal space efficiency by allowing sixtel kegs to be stacked multiple layers high while simultaneously being tapped and dispensed into a draught beer system. Said apparatus having upper and lower portions which are fastened together but are separable. Each portion having a “collar” of sufficient height to receive the top or bottom of either sixtel keg being stacked and maintaining them in a stable vertical position in avoidance of tipping. The device's upper portion, when separated from the lower portion, has “collar fins” projecting downward, which, in association with the upper collar, can also be utilized to stack stored sixtel kegs sans tapping. Said apparatus provides the same functionality when utilized in conjunction with Cornelius kegs.
